(19) United States
(12) Patent Application Publication
(10) Pub. No.: US 2019/0100448 A1
(43) Pub. Date: Apr. 4, 2019

(54) AMPHOTERIC POLYMER, PROCESS FOR PRODUCTION THEREOF, AND USE THEREOF, TO TREAT AQUEOUS DISPERSIONS

(71) Applicant: BASF SE, Ludwigshafen am Rhein (DE)

(72) Inventors: Daniel CHIPFUNHU, Waterford (AU); Holger MISSLITZ, Trostbert (DE); Tara Michele HASKELL, Somerby (AU)

(73) Assignee: BASF SE, Ludwigshafen am Rhein (DE)

(21) Appl. No.: 16/095,061

(22) PCT Filed: Apr. 20, 2017
(86) PCT No.: PCT/EP2017/059395

§ 371 Date: Oct. 19, 2018

(30) Foreign Application Priority Data
Apr. 21, 2016 (EP) 16166346.3

(51) Int. Cl. C02F 1/56; C08F 220/56; C02F 11/147

(52) U.S. Cl. CPC C02F 1/56; C08F 220/56; C02F 2103/10; C08F 2800/10; C02F 11/147

(57) ABSTRACT

A polymer formed from a monomer mixture comprising, (a) from 77 to 88 mol % of acrylamide or methacrylamide; (b) from 11.9 to 18 mol % of 2-acrylamido-2-methylpropane sulphonic acid, or salts thereof; and (c) from 0.1 to 5 mol % of a quarternary ammonium salt of dimethylaminoethyl acrylate or dimethylaminoethyl methacrylate, in which the quaternary ammonium salt of the monomer component (c) is the methyl chloride salt or dimethyl sulphate salt, preferably the methyl chloride or dimethyl sulphate quaternary ammonium salt of dimethylaminoethyl acrylate, more preferably the methyl chloride quaternary ammonium salt of dimethylaminoethyl acrylate, and in which the polymer has a reduced specific viscosity of at least 5 dL/g. The invention also provides a process for preparing this polymer and also a process for treating an aqueous slurry comprising particulate material employing said polymer.

One aspect of the present invention relates to an amphoteric polymer. Another aspect of the present invention relates to a process for producing an amphoteric polymer. A further aspect of the present invention relates to a process of treating an aqueous slurry employing an amphoteric polymer, such as processes for treating slurries of tailings in a vessel.

Various high molecular weight polymers are well-known in the literature and patents. High molecular weight polymers produced from water-soluble ethylenically unsaturated monomers. Typically, such polymers may be non-ionic, anionic or cationic. Amphoteric polymers which carry both anionic and cationic repeating monomer units have also been described. High molecular weight polymers have applications in a number of fields such as flocculants for use in solids, liquids separation processes, for instance in the water, mining and paper industries; thickening agents for improving the rheology of products, for instance in the personal care industries; rheology improving chemicals for injection fluids in the oil industry; absorbents for a variety of industries, such as agriculture, personal hygiene products etc.

High molecular weight polymers formed from acrylamide, often with other ethylenically unsaturated comonomers have been known for many years. Usually such polymers are referred to as polyacrylamides.

WO-A-1998/022557 discloses polymers that are formed from anionic monomers, cationic monomers and optionally non-ionic monomers. Suitable anionic monomers include various carboxylic acid or sulphonic acid monomers, such as the sodium salt of acrylamido tertiary butyl sulphonic acid. Various cationic monomers are suggested, such as the methyl chloride salt of dimethyl amino ethyl acrylate. This disclosure indicates that the polymers can be used as additives to prevent the formation, growth and/or agglomeration of gas hydrate crystals in a mixture of water and crude petroleum/natural gas constituents during the extraction or transport of crude petroleum and/or natural gas.

WO-A-2001/06999 and WO-A-2001/005365 describe low molecular weight water-soluble ampholyte polymers of quaternary ammonium monomers; (meth) acrylic acid or 2-(meth) acrylamido-2-methyl propane sulphonic acid; and optionally a C₁-C₂₂ alkyl (meth) acrylate acrylamide or methacrylamide. The polymers are said to be useful in hair, skin and nail conditioning; paper coating; and subterranean well drilling and well cementing operations.

FR-A-2900411 discloses processes of treating a mineral material by at least one amphoteric polymer. The amphoteric polymer contains at least one anionic monomer which is ethylenically unsaturated and can be monocarboxylic acid including acrylic acid, dicarboxylic acid, sulphonated monomer, phosphonate or phosphate monomers; at least one cationic monomer chosen from quaternary ammonium monomers such as acryloyloxy ethyl trimethylammonium chloride; and optionally at least one non-ionic monomer, such as acrylamide.

WO-A-2009/052018 discloses a method of enhancing flux of tailings settling pond water from an oil sands process through a membrane separation system and purify the water. The process is said to employ one or more water-soluble cationic, amphoteric, zwitterionic polymers or a combination thereof.

US-A-2009/0065443 reveals a water treatment method comprising adding an amphoteric polymer flocculant to polluted water to flocculate suspended solids so that the polluted water becomes treated water, and filtering the treated water. An inorganic flocculant can be added to the treated water of the flocculation treatment before filtering the treated water.

US-A-2007/0287815 discloses high molecular weight associative amphoteric polymers for increasing the viscosity of aqueous solutions comprising at least one cationic monomer derived from acrylamide bearing at least one hydrophobic chain of 8-30 carbon atoms; 1-99.9 mole % of at least one anionic monomer; and 1-99 mole % of one or several non-ionic water-soluble monomers. The aqueous solutions containing these polymers are said to have five uses in industry, in particular the oil, paper, water treatment, mining, cosmetics, textile, detergency industries.

Canadian patent application 2710049 refers to a method for reducing or preventing in oil sands operations, the blockage of pipelines transporting tailings material containing bitumen comprising injecting into the pipeline at least one water-soluble polymer.

WO-A-2013/188982 concerns techniques for dewatering thick fine tailings that may include one or more pretreatment steps, such as pre-shearing to reduce the yield stress prior to flocculation, hydrocarbon removal below a threshold to improve flocculation and dewatering, flocculant dosing on clay basis, and providing certain properties of the thick fine tailings related to coarse and fine particle sizes and/or chemistry such as divalent cation content. Various advantages are said to result from pre-treatments based on thick fine tailings properties, such as reduced flocculant dosage requirements, improved dispersion of flocculant into the thick fine tailings and/or enhanced dewatering.

WO-A-2001/04201 relates to high molecular weight water-soluble zwitterionic polymers derived from zwitterionic and non-ionic monomer units, and to use the polymers in papermaking processes.

EP-A-1889856 teaches inverse emulsions usable as thickeners for cosmetics. Disclosed are inverse emulsions in which the ratio between the aqueous phase and the organic phase is from 4:1 to 2:1 and containing from 20 to 70% by weight of an acrylic polymer comprising monomeric units derived from 2-acrylamido-2-methyl propane sulphonic acid; at least one cationic acrylic monomer; acrylic or methacrylic acid; at least one polyfunctional monomer.

Chinese 103483497 describes a composition formed from 8 mol acrylamide; 1-5 mol acrylic acid; 0.15-mol 2-acrylamido-2-methyl propane sulphonic acid; 0.15-0.6 mol methacrylamidopropyltrimethyl ammonium chloride as a water plugging agent.

Chinese 103059218 describes the manufacture of cationic polyacrylamide using 20-50 weight % anionic monomer 5-80 weight % cationic monomer and 20-95% acrylamide.

Chinese 102702424 reveals a zwitterionic polymer based on 40 mol % dimethyl amino ethyl acrylate, methyl chloride quaternary salt; 30 mol % acrylamide; 30 mol % 2-acrylamido-2-methyl propane sulphonic acid.

WO-A-2013/138156 teaches a high pressure, high temperature fluid loss additive and in particular, a fluid loss additive for oilfield drilling applications. The fluid loss additive comprises a terpolymer of acrylamide, 2-acrylamido-2-methylpropane sulphonic acid and a cationic monomer, such as acrylamidopropyl-trimethyl ammonium chloride and/or methacrylamidopropyl-trimethyl ammonium chloride.

WO-A-2013/162902 describes compositions containing a combination of polymers with high fluid loss control and retention of rheological properties. Disclosed are fluid loss additives comprising a terpolymer of acrylamide, 2-acrylamido-2-methylpropanesulphonic acid and a cationic monomer, such as acrylamidopropyl-trimethyl ammonium chloride and/or methacrylamidopropyl-trimethyl ammonium chloride.

WO-A-2014/046979 discloses a composition of a filtration aid promoter which may include a synthetic amphoteric polymer.

It is known to concentrate aqueous suspensions of solids in aqueous liquids by the use of flocculants, resulting in flocculation of the solids which will facilitate the separation of the solids from the liquid. In many processes, the flocculated solids settle to form a bed of solids by a sedimentation action. In other processes separation can be facilitated by mechanical dewatering, for instance in pressure filtration, centrifugation, by belt thickeners and by belt presses.

The types of flocculants added to an aqueous suspension of solids to effect flocculation will often depend upon the type of solids suspensions. Generally, such suspensions of solids tend to be flocculated by high molecular weight polymers. Examples of this are described in WO-A-9314852 and U.S. Pat. No. 3,975,496 regarding the flocculation of mineral suspensions such as red mud. Other disclosures of high molecular weight polymeric flocculants include U.S. Pat. No. 6,447,687, WO-A-0216495 and WO-A-02083258 dealing with the flocculation of sewage sludge. It is known to add other chemical additives sometimes in order to condition the suspension. For instance, aqueous suspensions of solids may first be coagulated by a high charge density polymeric coagulant such as polyDADMAC or inorganic coagulants including ferric chloride.

Aqueous suspensions are frequently concentrated in a stirred vessel. Typically, the suspension will enter from the top of the vessel and the suspension flocculates on addition of flocculant. The flocculated solids would tend to settle to the lower end of the vessel leaving the clarified aqueous liquid at the upper end of the vessel.

One frequently used type of vessel for the concentration of suspensions is a gravity thickener vessel. In a gravity thickener vessel a continual flow of the aqueous solids suspension is typically fed into the thickener vessel and treated with a flocculant. Normally, the aqueous solids suspension is fed into a central feed well within the gravity thickener vessel. The flocculated solids so formed settle to form a bed of solids, which tend to undergo consolidation at the lower end of the vessel. In general, the bed of solids will be removed from the lower end of the gravity thickener vessel as an underflow. Typically, it is desirable to remove as much water as possible from the settled bed of solids in order to gain a higher density underflow and to recover a maximum of the process water. It is usual to pump the underflow to a surface holding area, often referred to as a tailings pit or dam, or alternatively the underflow may be mechanically dewatered further by, for example, vacuum filtration, pressure filtration or centrifugation. In such gravity thickener vessels the clarified aqueous liquid will usually leave the vessel as an overflow and be collected in a launder which surrounds the rim of the top of the vessel.

It is usual to treat a variety of aqueous suspensions of solids which are mineral in nature and/or derived from mining industry processes by effecting a solids, liquids separation process in a gravity thickener vessel. Typically, the aqueous suspensions of solids include suspensions of coal fine tailings, china clay, mineral sands tailings, oil sands tailings, gold tailings, red mud, copper tailings, nickel tailings, copper ore concentrate, nickel ore concentrate etc.

It is generally important to achieve an acceptable combination of solids settling rate and overflow clarity and employing an acceptable polymer dose. Non-ionic polyacrylamides have been found to give a good combination of settling rate and overflow clarity. However, in order to achieve this combination, high doses of polymer tend to be required. Various anionic polymers have been found to be more dose efficient but tend not to provide the same degree performance of settling rate and overflow clarity as non-ionic polyacrylamides.

Therefore, an objective of the present invention is to provide a flocculant which exhibits an improved combination of settling rate and overflow clarity over the anionic polymers and yet be more dose efficient than the non-ionic polyacrylamides.

Thus, according to one aspect of the present invention, we provide a polymer formed from a monomer mixture comprising,
(a) from 77 to 88 mol % of acrylamide or methacrylamide;
(b) from 11.9 to 18 mol % of 2-acrylamido-2-methylpropane sulphonic acid, or salts thereof; and
(c) from 0.1 to 5 mol % of a quaternary ammonium salt of dimethylaminoethyl acrylate or dimethylaminoethyl methacrylate,
   in which the quaternary ammonium salt of the monomer component (c) is the methyl chloride salt or dimethyl sulphate salt, preferably the methyl chloride or dimethyl sulphate quaternary ammonium salt of dimethylaminoethyl acrylate, more preferably the methyl chloride quaternary ammonium salt of dimethylaminoethyl acrylate,
   and in which the polymer has a reduced specific viscosity of at least 5 dL/g.

In a further aspect of the invention, we also provide a process for treating an aqueous slurry comprising particulate material, the process comprising the steps of contacting the aqueous slurry with the aforementioned polymer of the invention.

In a still further aspect of the invention, we also provide a process for producing the aforementioned polymer of the invention comprising the steps of combining the monomers
acrylamide or methacrylamide;
2-acrylamido-2-methylpropane sulphonic acid, or salts thereof; and
a quaternary ammonium salt of dimethylaminoethyl acrylate or dimethylaminoethyl methacrylate,
to produce a monomer mixture comprising,
   (a) from 77 to 88 mol % of acrylamide or methacrylamide;
   (b) from 11.9 to 18 mol % of 2-acrylamido-2-methylpropane sulphonic acid, or salts thereof; and
   (c) from 0.1 to 5 mol % of a quaternary ammonium salt of dimethylaminoethyl acrylate or dimethylaminoethyl methacrylate,
in which the quaternary ammonium salt of the monomer component (c) is the methyl chloride salt or dimethyl sulphate salt, preferably the methyl chloride or dimethyl sulphate quaternary ammonium salt of dimethylaminoethyl acrylate, more preferably the methyl chloride quaternary ammonium salt of dimethylaminoethyl acrylate,
   contacting the monomer mixture with at least one initiator to cause the monomers of the monomer mixture to polymerise to produce the polymer.

The 2-acrylamido-2-methylpropanesulphonic acid may be as free acid or as a salt. Typically, the salt may be an ammonium salt, organic ammonium salt, alkali metal salt or an alkaline earth metal salt. Suitably, the salts may be sodium, potassium, lithium, magnesium, beryllium, or calcium. The salt may be of a different metal such as aluminium. Preferably the salt is either sodium, potassium or calcium.

The monomer mixture used to form the polymer of the present invention comprises (a) from 77 to 88 mol % of acrylamide or methacrylamide; (b) from 11.9 to 18 mol % of 2-acrylamido-2-methylpropane sulphonic acid or salts thereof; and (c) from 0.1 to 5 mol % of a quaternary ammonium salt of dimethylaminoethyl acrylate or dimethylaminoethyl methacrylate. Within this a desirable polymer may comprise from 79.5 to 87 mol % acrylamide or methacrylamide; from 12.5 to 16.5 mol % of 2-acrylamido-2-methylpropane sulphonic acid or salts thereof; and from 0.5 to 4 mol % of a quaternary ammonium salt of dimethylaminoethyl acrylate or dimethylaminoethyl methacrylate.

Thus, one desirable polymer may be formed from the monomer mixture comprising,
(a) from 79.5 to 87 mol % of acrylamide or methacrylamide;
(b) from 12.5 to 16.5 mol % of 2-acrylamido-2-methylpropane sulphonic acid, or salts thereof; and
(c) from 0.5 to 4 mol % of the quaternary ammonium salt of dimethylaminoethyl acrylate or dimethylaminoethyl methacrylate.

A still further desirable polymer includes a polymer in which the monomer mixture comprises,
(a) from 81 to 86.5 mol % of acrylamide or methacrylamide;
(b) from 13 to 16 mol % of 2-acrylamido-2-methylpropane sulphonic acid, or salts thereof; and
(c) from 0.5 to 3 mol % of the quaternary ammonium salt of dimethylaminoethyl acrylate or dimethylaminoethyl methacrylate.

In any of the aforementioned described polymer definitions according to the present invention, it is preferred that monomer component (c) is the quaternary ammonium salt of dimethylaminoethyl acrylate. Thus, component (c) is preferably the methyl chloride or dimethyl sulphate quaternary ammonium salt of dimethylaminoethyl acrylate, more preferably the methyl chloride quaternary ammonium salt of dimethylaminoethyl acrylate.

It is preferred that monomer component (a) is acrylamide.

Thus, an especially preferred polymer according to the present invention is formed from a monomer mixture comprising,
(a) from 77 to 88 mol %, preferably from 79.5 to 87 mol %, more preferably from 81 to 86.5 mol %, of acrylamide;
(b) from 11.9 to 18 mol %, preferably from 12.5 to 16.5 mol %, more preferably from 13 to 16 mol %, of 2-acrylamido-2-methylpropane sulphonic acid, or salts thereof, preferably the sodium or potassium salt; and
(c) from 0.1 to 5 mol %, preferably from 0.5 to 4 mol %, more preferably from 0.5 to 3 mol %, of the methyl chloride quaternary ammonium salt of dimethylaminoethyl acrylate,
   in which the polymer has a reduced specific viscosity of at least 5 dL/g.

The polymers, according to all the aforementioned aspects of the present invention have a reduced specific viscosity of at least 5 dL/g. For some applications it may be desirable that the reduced specific viscosity is from 5 to 12 dl/g, desirably from 5 to 9 dl/g, for instance, from 7 to 9 dl/g. Nevertheless, in many applications, it is more desirable that the reduced specific viscosity is at least 10 dl/g. Desirably, the polymers may have a reduced specific viscosity of at least 12 dL/g and preferably from 13 to 20 dL/g.

The polymers, according to the present invention may have weight average molecular weights in excess of 800,000 or at least 1,000,000 g/mol. In many cases, we would expect that the weight average molecular weight is considerably higher. The reduced specific viscosity is measured at 25° C. using 1M sodium chloride, buffered to pH 7.

A suitable method for measuring reduced specific viscosity is according to the following procedure.

Reduced specific viscosity measurements:

Preparation of stock solution:
0.1 g of polymer+5 ml of acetone
94.9 g of deionised water
2 hours mixing (tumble wheel)

Preparation of diluted measuring solution (125 ppm):
12.5 g of the stock solution is weight in a 100 ml volumetric flask
50 ml of buffer are added (recipe see below)
Addition of deionised water to the 100 ml mark of the volumetric flask
5 min shaking

Measurement:
The 125 ppm concentrated polymer solution is transferred to the Ubbelohde
Measurement carried out at 25° C. at the capillary viscometer (Lauda iVisc)

Preparation of pH 7 buffer solution

A stock solution of 2M sodium chloride buffered at pH 7 is prepared and then diluted to give a polymer solution in 1M sodium chloride.
Recipe for stock buffer solution.

| | |
|---|---|
| Sodium chloride | 583.3 ± 0.1 g |
| Disodium hydrogen orthophosphate.•12 H₂O | 161.3 ± 0.1 g |
| Sodium dihydrogen orthophosphate•2 H₂O | 6.9 ± 0.01 g |

Weigh the above into a 5-liter beaker, add approximately 4 liter of deionised water and stir until dissolved.

Transfer the solution to a 5 liter volumetric flask and wash the beaker into the flask with deionised water, when all the contents of the beaker have been transferred to the volumetric flask make up to the mark with deionised water. Agitate the flask to ensure the solution is completely mixed.

The polymers according to the present invention may be water insoluble, for instance cross-linked and water swellable but water insoluble. Nevertheless, it is preferred that the polymers of the present invention are water-soluble.

The polymers, according to the present invention typically have a solubility in water of at least 5 g of polymer in 100 mL of water at 25° C.

In the invention, the polymer may be formed by any suitable polymerisation process. The polymers may be prepared for instance as gel polymers by solution polymerisation, water-in-oil suspension polymerisation or by water-in-oil emulsion polymerisation. Gel polymers prepared by solution polymerisation are generally further processed to provide a solid powder. Thus, in one form of the invention, the polymers may be provided in the form of a solid powder. Polymers prepared by water in oil suspension polymerisation tend to be provided in the form of beads which may be substantially spherical particles. Thus, in a further form of the invention, the polymers may be provided in the form of beads or more specifically substantially spherical particles.

In the further aspect of the present invention, the polymers of the present invention are particularly suitable in the process for treating an aqueous slurry comprising particulate material. This process employs the steps of contacting the aqueous slurry with the aforementioned polymer according to the present invention.

The polymer according to the present invention may be contacted with the aqueous slurry by any convenient means. Typically, the polymer will be fed into the aqueous slurry, for instance at a specific dose rate or range of specific dose rates. Suitably the aqueous slurry will be contacted with an aqueous solution of the polymer.

The aqueous solution of polymer is typically obtained by dissolving the polymer in water or by diluting a more concentrated solution of the polymer. Generally solid particulate polymer, for instance in the form of powder, beads or substantially spherical particles, is dispersed in water and allowed to dissolve with agitation. This may be achieved using conventional make up equipment. Desirably, the polymer solution can be prepared using the Auto Jet Wet (trademark) supplied by BASF, for example as described in GB 1501938. The polymer solution may also be prepared according to any of the disclosures of U.S. Pat. No. 4,518,261, U.S. Pat. No. 5,857,773, U.S. Pat. No. 6,039,470, U.S. Pat. No. 5,580,168, U.S. Pat. No. 5,540,499, U.S. Pat. No. 5,164,429, U.S. Pat. No. 5,344,619. The polymer solution may even be prepared using polymer slicing/shearing equipment, for instance as described by U.S. Pat. No. 4,529,794, U.S. Pat. No. 4,874,588, or even any of the disclosures CA 2667277, CA 2667281, CA 2700239, CA 2700244, CA 2775168, CA 2787175, CA 2821558 or US 2009/095688. Alternatively, the polymer may be supplied in the form of a reverse phase emulsion or dispersion which can then be inverted into water by conventional techniques.

The concentration of the aqueous polymer solution may be any suitable concentration which would facilitate the polymer solution to be fed into and mix with the aqueous slurry. Although it is conceivable that the aqueous polymer solution may be 5% weight/volume or more, it is usual that the concentration be less than 5% weight/volume. Typically, the polymer solution will tend to be below 3% weight/volume. Usually the aqueous polymer concentration will be at least 0.01% weight/volume. Suitably the aqueous polymer concentration may be from 0.01% to 5% weight/volume, typically from 0.02% to 3%, often from 0.05% to 1%.

Suitable doses of the polymer, according to the present invention, range from 5 grams to 10,000 grams per tonne of slurry material solids. Generally, the appropriate dose can vary according to the particular material and material solids content. Preferred doses are in the range from 10 to 3,000 grams per tonne, especially from 10 to 1000 grams per tonne, while more preferred doses are in the range of from 60 to 200 grams per tonne, especially from 85 to 185 g per tonne.

Preferably, the particulate material comprised in the aqueous slurry is mineral in nature and/or derived from a mining operation. Typically, the aqueous slurry may be selected from mining and refining operations in the group consisting of bauxite, base metals, precious metals, iron, nickel, coal, mineral sands, oil sands, china clay, diamonds and uranium. More preferably, the aqueous slurry comprises tailings. More preferably still, the aqueous slurry comprises any of coal tailings, china clay, mineral sands tailings, gold tailings, copper tailings, nickel tailings or oil sands tailings. Other suitable slurries which may be treated by the present invention include copper ore concentrates and nickel ore concentrates.

For many of the aqueous slurries useful in accordance with the present invention the particulate material solids in the aqueous slurry should be at least 90% by weight greater than 0.5 microns. Frequently the particles in slurry will be at least 90% by weight at least 0.75 microns and preferably at least 90% by weight at least one or two microns. Typically, suspended particles may have a particle size at least 90% by weight up to 2mm and usually at least 90% by weight within the range above 0.5 microns to 2 mm. Preferably suspended particles will be at least 90% by weight up to 1 mm or more preferably at least 90% by weight up to 750 microns, especially at least 90% by weight within the range of between one or two microns and one or two millimeters.

However, other aqueous slurries which may be treated by the present invention may have different particle size ranges. Such slurries include aqueous slurries comprising mature fine tailings (MFT). MFT are typically derived from tailings lagoons and tailings ponds where oil sands tailings have been deposited.

The composition of mature fine tailings tends to be highly variable. The upper part of the stratum may have a mineral content of about 10% by weight but at the bottom of the stratum the mineral content may be as high as 50% by weight. The variation in the solids content is believed to be as a result of the slow settling of the solids and consolidation occurring over time. The average mineral content of the MFT tends to be of about 30% by weight.

The MFT generally comprises a mixture of sand, fines and clay. Generally, the sand may referred to siliceous particles of a size greater than 44 μm and may be present in the MFT in an amount of up to 15% by weight. The remainder of the mineral content of the MFT tends to be made up of a mixture of clay and fines. Generally, the fines refer to mineral particles no greater than 44 μm. The clay may be any material traditionally referred to as clays by virtue of its mineralogy and will generally have a particle size of below 2 μm. Typically, the clays tend to be water swelling clays, such as montmorillonites. The clay content may be up to 75% of the solids.

Additional variations in the composition of MFT may be as a result of the residual hydrocarbon which may be dispersed in the mineral or may segregate into mat layers of hydrocarbon. The MFT in a pond not only has a wide variation of compositions distributed from top to bottom of the pond but there may also be pockets of different compositions at random locations through-out the pond.

In addition, aqueous suspensions waste solids from mining and mineral processing operations including mining tailings, such as MFT, held in ponds or holding areas may also contain coarse debris. The type and composition of this coarse debris depends on the origin of the suspension. In the case of MFT the coarse debris tends to be of different sizes, shapes and chemical compositions. For instance, MFT may include coarse debris such as biomass, such as wood or other plant material; petrified matter; solids having a density low enough to float at or near the surface of the pond; glass; plastic; metal; bitumen globules; or mats. The coarse debris found other mining tailings may include similar debris as in the case of MFT, with the exception of bitumen materials and may also include other debris materials such as lumps of ore or other masses depending on the geology of the ore mine, the ore extraction processing technique, or the location of the tailings pond.

The aqueous slurry may comprise thin fine tailings (TFT).

The aqueous slurry may comprise whole fine tailings (WFT).

The process of treating the aqueous slurry of particulate material, according to the present invention may be carried out in a vessel and the particulate material settles to form a consolidated layer of solid particles by gravity sedimentation. Typically, the vessel should be a stirred vessel, such as a gravity thickener vessel. Desirably, the polymer according to the present invention will contact the aqueous slurry by introducing the polymer into the vessel or into the aqueous slurry feedline before the slurry enters the vessel.

The aqueous slurry will undergo flocculation on contact with the polymer. The so formed flocculated solids should then settle to the lower end of the vessel, leaving the clarified aqueous liquid at the upper end of the vessel.

Preferably the process of treatment of the aqueous slurry is conducted employing a gravimetric thickener vessel and thickened particulate solids are removed from the base of the vessel as an underflow and aqueous liquor is removed from the vessel by an overflow means, preferably an overflow launder.

Typically, the aqueous slurry will be fed into the top of the gravity thickener vessel, normally within the feed well. The polymer may be introduced into the aqueous slurry prior to it entering the gravity thickener vessel or it may be introduced into the top of the vessel, typically within the feed well. The slurry solids should then undergo flocculation and the so formed flocculated solids will settle to form a bed of solids. In such a process the solids will undergo consolidation as more solids settle. The solids would then be removed from the lower end of the gravity they can vessel as an underflow.

The underflow solids may be pumped to a surface holding area, for instance, a tailings pit or dam. Alternatively, the underflow solids may be further processed, for instance, by mechanical dewatering, for instance, by vacuum filtration, pressure filtration or centrifugation.

The invention also provides a process for producing the polymer defined according to the various aspects of the invention.

The process for producing the polymer according to the present invention comprises the steps of

combining the monomers
acrylamide or methacrylamide;
2-acrylamido-2-methylpropane sulphonic acid, or salts thereof; and
a quaternary ammonium salt of dimethylaminoethyl acrylate or dimethylaminoethyl methacrylate,
to produce a monomer mixture comprising,
   (a) from 77 to 88 mol % of acrylamide or methacrylamide;
   (b) from 11.9 to 18 mol % of 2-acrylamido-2-methylpropane sulphonic acid, or salts thereof; and
   (c) from 0.1 to 5 mol % of a quaternary ammonium salt of dimethylaminoethyl acrylate or dimethylaminoethyl methacrylate,
in which the quaternary ammonium salt of the monomer component (c) is the methyl chloride salt or dimethyl sulphate salt, preferably the methyl chloride or dimethyl sulphate quaternary ammonium salt of dimethylaminoethyl acrylate, more preferably the methyl chloride quaternary ammonium salt of dimethylaminoethyl acrylate,
   contacting the monomer mixture with at least one initiator to cause the monomers of the monomer mixture to polymerise to produce the polymer.

Desirably a thermal initiator system may be included. Typically, a thermal initiator would include any suitable initiator compound that releases radicals at an elevated temperature, for instance azo compounds, such as azo-bis-isobutyronitrile (AIBN), 4,4′-azobis-(4-cyanovalereic acid) (ACVA) and any mixture thereof.

In the process the at least one initiator may comprise redox initiators. These would normally be employed as a redox couple. Redox couples consist of an oxidizing agent and a reducing agent. The oxidizing agent, for instance, may be at least one of peroxides, persulfates or permanganate, an alkali metal chlorate or bromate. Examples of reducing agents are ascorbic acid, glucose or ammonium or alkali metal hydrogen sulfite, sulfite, thiosulfate or sulfide, or ferrous ammonium sulfate.

Desirably, the at least one initiator comprises redox initiators and at least one thermal initiator. Suitably, the at least one initiator may include a redox couple in conjunction with at least one azo compound.

Alternatively, polymerisation may be initiated by photoinitiation system. Typically, this may employ at least one suitable photoinitiator and irradiating the monomer using a suitable actinic radiation, for instance ultraviolet light, microwave energy or infrared energy.

Generally, the temperature of the polymerisation should rise to at least 60° C., typically from 70° to 95° C.

The monomers of the monomer mixture may be polymerised by aqueous solution polymerisation. Thus, an aqueous solution comprising the monomer mixture would be subjected to an initiation step, for instance, using at least one initiator as described above. Typically, the aqueous solution of monomer would be contained in a vessel or alternatively may for instance be as a thin film, for instance on a belt. The polymerisation of the aqueous solution of the monomer mixture would proceed to form an aqueous polymer gel. Once the polymerisation is complete the aqueous polymer gel may then be cut into smaller pieces and then dried to substantially dehydrate the polymer. The substantially dehydrated polymer may then be ground to form particulate solids which may be termed a solid powder. Such a process may be conducted by a batch procedure or as a continuous process.

The polymerisation may alternatively be carried out by reverse-phase (water in oil) suspension polymerisation. In such a process an aqueous solution of the monomer mixture may be dispersed in a stirred vessel containing a non-aqueous liquid, such as Exxsol D40, to provide droplets of the aqueous monomer suspended in the non-aqueous liquid. Typically, a stabilising material or a protective colloid may be used to stabilise the aqueous droplets of monomer from coalescence. Suitable stabilising materials and protective colloids are described in the patents and literature. It may be desirable to use a surfactant for this purpose. Preferably, the stabilising material is an amphipathic polymer. As the polymerisation proceeds, the monomer droplets polymerise to become particles of polymer, typically referred to as beads. Typically, the polymer beads have a more regular physical form than the polymer powder products. The so formed polymer particles desirably may be substantially spherical particles.

The following examples are intended to illustrate the invention without being in any way limiting the scope of invention.

### EXAMPLES

A polymer (Polymer B) according to the present invention was prepared by the following procedure.

### Materials Used

Na-ATBS—sodium salt of 2-acrylamido-2-propane sulphonic acid

DMA 3Q—methyl chloride quaternary ammonium salt of dimethylaminoethyl acrylate.

Trilon C—diethylenetriaminepentaacetic acid

ACVA—4,4′-azobis-(4-cyanovalereic acid)

AIBN—azobisisobutyronitrile

APS—ammonium persulphate

FAS—ferrous ammonium sulphate

### Procedure

82 g of deionised water was poured in a reaction vessel equipped with magnetic stirrer, pH meter and thermometer. Then 112.7 g of an aqueous solution of Na-ATBS (50% active content), 180.0 g acrylamide (50% active content), 0.4 g Trilon C, 4.7 g adipic acid, 11.2 g DMA3Q (80% active content), and 3.0 g of ACVA (4% in a 5wt % NaOH solution) were added successively. After the adjustment of the pH to 4.0 with sulfuric acid and addition the residual water (to reach a desired monomer concentration of 40 wt %), the monomer solution was cooled to 0° C. during nitrogen purging and 3 g of an AIBN solution (4 wt % solution concentration) was poured into the vessel. The polymerisation reaction was started by the addition of 0.12 g APS (0.5 wt % concentrated solution) and 0.24 g FAS (0.5 wt % concentrated solution). During polymerisation reaction the temperature raised to 80° C.-90° C. within 100 min and a solid gel was obtained. After polymerisation, the solid gel was cooled down to about 50° C. and was then minced by means of a conventional meat mincer to form gel chips. Subsequently the gel chips were dried in a drying oven for 2 hours at 80° C. The dry gel chips were ground to obtain a white powder.

The resulting polymer was formed from 15.8 mol % sodium salt of 2-acrylamido-2-methyl sulphonic acid; 81.2 mol % acrylamide; and 3.0 mol % methyl chloride quaternary ammonium salt of dimethyl amino ethyl acrylate.

On testing, the polymer was found to exhibit a reduced specific viscosity of 15.5 dL/g.

### Procedure for Reduced Specific Viscosity Measurements

Preparation of stock solution:
0.1 g of polymer+5 ml of acetone
94.9 g of deionised water
2 hours mixing (tumble wheel)

Preparation of diluted measuring solution (125 ppm):
12.5 g of the stock solution is weight in a 100 ml volumetric flask
50 ml of buffer are added (recipe see below)
Addition of deionised water to the 100 ml mark of the volumetric flask
5 min shaking

Measurement:
The 125 ppm concentrated polymer solution is transferred to the Ubbelohde
Measurement carried out at 25° C. at the capillary viscometer (Lauda iVisc)

Preparation of pH 7 buffer solution

A stock solution of 2M sodium chloride buffered at pH 7 is prepared and then diluted to give a polymer solution in 1M sodium chloride.
Recipe for stock buffer solution.

| | |
|---|---|
| Sodium chloride | 583.3 ± 0.1 g |
| Disodium hydrogen orthophosphate.•12 H₂O | 161.3 ± 0.1 g |
| Sodium dihydrogen orthophosphate•2 H₂O | 6.9 ± 0.01 g |

Weigh the above into a 5-liter beaker, add approximately 4 liter of deionised water and stir until dissolved.

Transfer the solution to a 5 liter volumetric flask and wash the beaker into the flask with deionised water, when all the contents of the beaker have been transferred to the volumetric flask make up to the mark with deionised water. Agitate the flask to ensure the solution is completely mixed.

Polymer A and Polymer C, each in accordance with the present invention, were produced by an analogous procedure to Polymer B.

Details of the polymer are summarised in Table 1

TABLE 1
Polymers of the Invention

| | | | | Reduced |
|---|---|---|---|---|
| | | | | specific |
| | Na-ATBS | Acrylamide | DMA 3Q | viscosity |
| Polymer | (mol %) | (mol %) | (mol %) | (dL/g) |
| Polymer A | 13.8 | 85.2 | 1.0 | 15.8 |
| Polymer B | 15.8 | 81.2 | 3.0 | 15.5 |
| Polymer C | 17.8 | 77.2 | 5.0 | 14.5 |

### Evaluation of the Polymers of the Invention

Polymers A, B, and C were evaluated in the treatment of an aqueous slurry of particulate solids to observe the overflow clarity and settling rate. These were compared to Comparative Polymer D formed from 12.8 mol % Na-ATBS and 87.2 mol % acrylamide; and Comparative Polymer E formed from 100% acrylamide.

China clay of around 20% w/w was prepared in tap water and let to stand for about a week, a process called aging. After aging for seven days, the 20% w/w china clay slurry was diluted to 4% w/w using tap water and pH adjusted to the desired level using dilute sulphuric acid or sodium hydroxide. 1000 ml of the 4% w/w china clay was sampled into a 1000 ml measuring cylinder using a Silverson mixer, or manually from a bucket agitated using a handheld mechanical mixer. The measuring cylinder was placed on a lab jack under an IKA stirrer with a three blade 4 cm diameter blade propeller stirrer attached, in such a way that the impeller was immersed in the slurry in the cylinder. The lab jack was adjusted so that the bottom of the impeller blade was in line with the 500 ml line of the measuring cylinder.

The slurry in the measuring cylinder was stirred at 700 rpm for 30 seconds before adding a known volume of 0.025% w/w polymer solution (prepared in accordance with standard procedure for preparing polymer solutions) to the edge of the vortex just above the surface of the substrate. Stirring was continued for exactly 10 seconds. After exactly 10 seconds, stirring was stopped and the time taken for the mudline to fall between the 900 ml and 700 ml marks was recorded for computing the settling rate. The flocs were left to settle and compact for 20 minutes and a sample of the supernatant was drawn from the top of the cylinder using a very clean syringe for determination of the clarity using a turbidity meter. The volume of the settled solids after the 20 minutes was also recorded.

The test work was repeated using at least four different polymer solution dose levels for each flocculant product tested at the set conditions. Generally, the settling rate range targeted was 2 m/hr to 30 m/hr. The tests were repeated for sufficient times to generate statistical analysis amenable data.

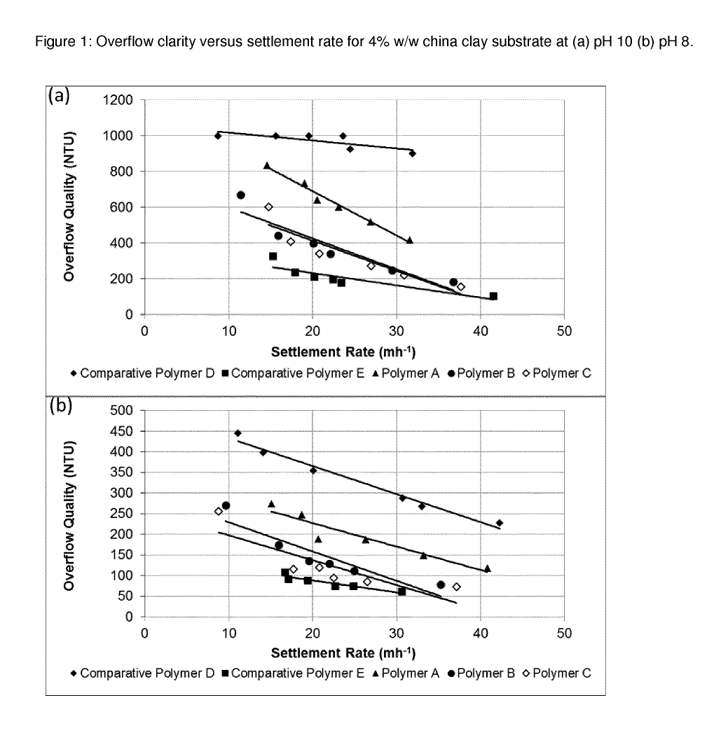

FIG. 1 shows the effect of the DMA 3Q content in the polymers of the invention by comparison to the comparative polymers in terms of supernatant (overflow) clarity for analogous settling rates. It can be seen that the polymers of the invention containing the DMA 3Q show a vast improvement in overflow clarity by comparison to Comparative Polymer D.

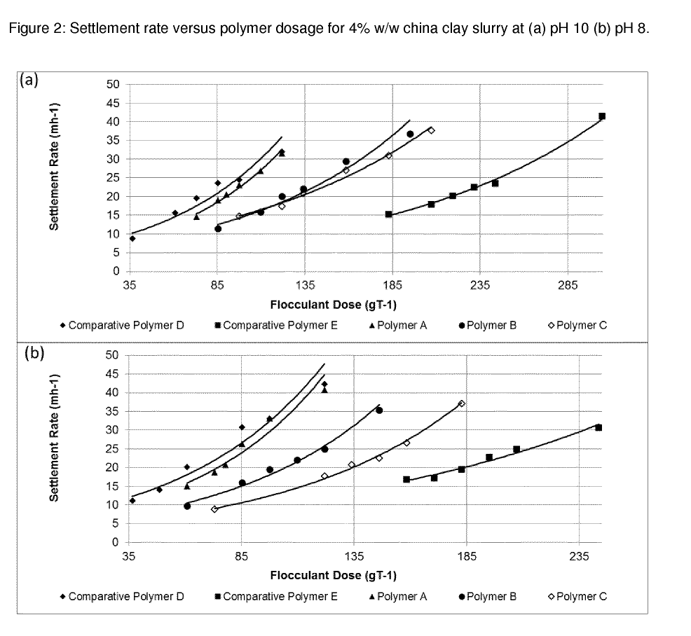

FIG. 2 shows the effect of the DMA 3Q content in the polymers of the invention by comparison to the comparative polymers in terms of settlement rate versus polymer dosage. It can be seen that the polymers according to the present invention exhibit a significant dose efficiency for a given settlement rate by comparison to Comparative Polymer E.

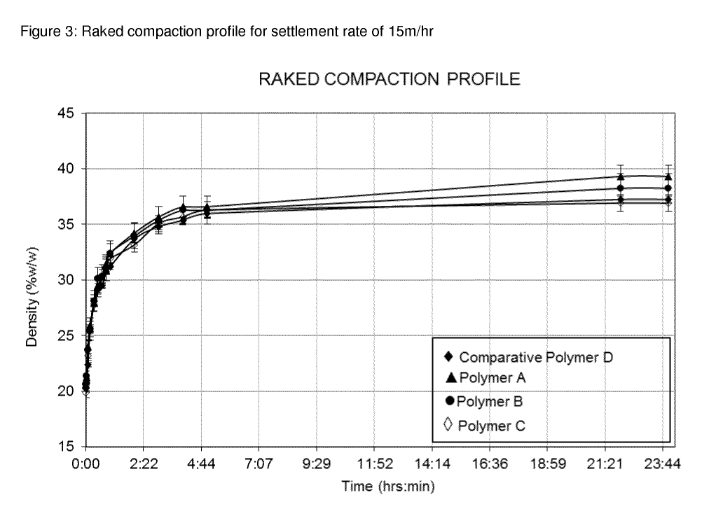

Additional so-called raked cylinder tests were conducted to determine the effect of DMA3Q on the underflow density. For this test work a settling rate—dose profile for each polymer product was established as described above. The dose rate that gave a settling rate of 15±1 m/hr was selected, whereby supernatant was separated from the settled solids (underflow) after 10 minutes. The settling rate test work was repeated 5 times with the underflow being kept. The underflow from these 5 tests for the same polymer at the same polymer dose were combined by carefully pouring into a 1000 ml measuring cylinder onto which a raking mechanism is affixed. Cylinder raking was carried out for 24 hours and the settled solids density determined over a 24 hour period. The density-time profiles (FIG. 3) show that the settled solids volume (underflow solids density) remains the same for Comparative Polymer D and the terpolymers tested. In other words, the terpolymers gave an improved overflow clarity at improved or similar underflow density as given by Comparative Polymer D.

Preparation of Comparative Polymers F and G

Comparative Polymer F and Polymer G were produced by an analogous procedure to Polymer B.

Details of the polymer are summarised in Table 2

TABLE 2
Comparative Polymers F and G

| | | | | | Reduced |
|---|---|---|---|---|---|
| | | Na- | | | specific |
| | Na-ATBS | acrylate | Acrylamide | DMA 3Q | viscosity |
| Polymer | (mol %) | (mol %) | (mol %) | (mol %) | (dL/g) |
| Polymer F | 0 | 13 | 67 | 20 | 20 |
| Polymer G | 13 | 0 | 67 | 20 | 12 |

### Evaluation of the Polymers of the Invention Compared to Comparative Polymers F and G

Polymers A, B, and C were evaluated in the treatment of an aqueous slurry of particulate solids to observe the settling rate in comparison to Comparative Polymer F, an amphoteric polymer formed from sodium acrylate in place of Na ATBS, a lower amount of acrylamide and a higher amount of DMA 3Q, and Comparative Polymer G, an amphoteric polymer formed from Na ATBS, a lower amount of acrylamide and a higher amount of DMA 3Q.

Polymers A, B, C, F and G were each evaluated by measuring the settlement rate at different doses of the respective polymers on a 4% China Clay slurry both pH 8 and pH 10. The preparation of the China Clay slurry and the settlement determination were carried out analogously to the aforementioned evaluation.

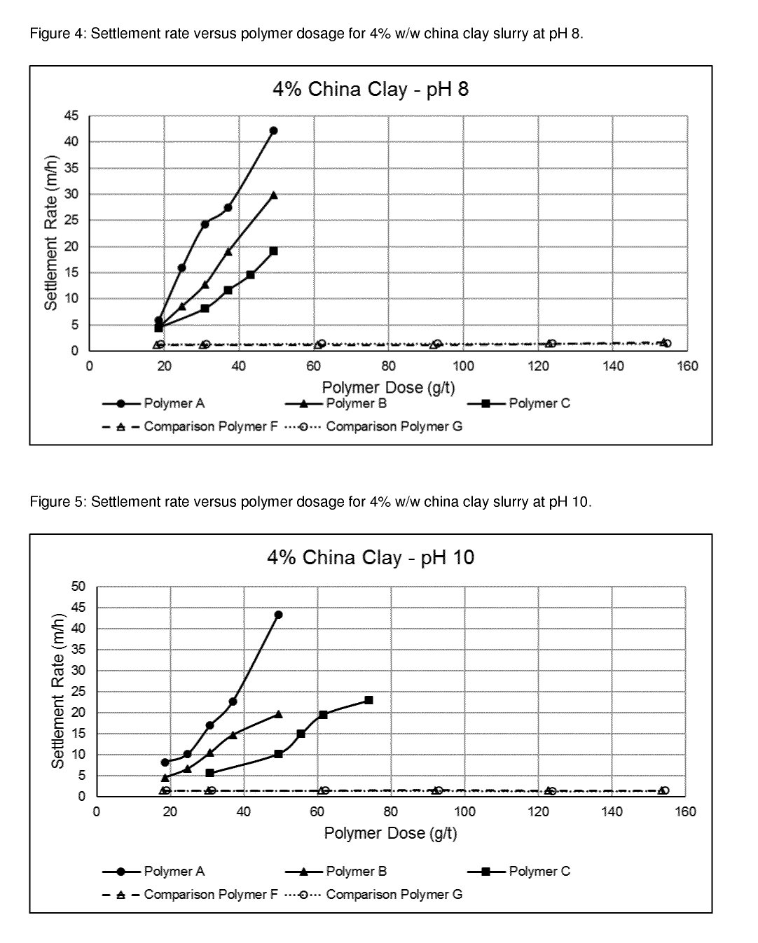

FIG. 4 shows the effect on settlement rate on a China Clay slurry at pH 8 by application of the three polymers of the invention A, B and C by comparison to the two Comparative Polymers F and G. It can be seen that the three polymers of the invention were effective at settling the China Clay solids whereas the two Comparative Polymers did not achieve any settling at any dose.

FIG. 5 shows the effect on settlement rate on a China Clay slurry at pH 10 by application of Polymers A, B and C (of the invention) by comparison to Polymers F and G (comparative). The results demonstrate that analogously to FIG. 4 the polymers of the invention were effective in settling the China Clay solids whereas the Comparative Polymers again did not achieve any settling at any dose.

1. A polymer formed from a monomer mixture comprising,
(a) from 77 to 88 mol % of acrylamide or methacrylamide;
(b) from 11.9 to 18 mol % of 2-acrylamido-2-methylpropane sulphonic acid, or a salt thereof; and
(c) from 0.1 to 5 mol % of a quaternary ammonium salt of dimethylaminoethyl acrylate or dimethylaminoethyl methacrylate,
wherein the quaternary ammonium salt is a methyl chloride salt or a dimethyl sulphate salt, and
the polymer has a reduced specific viscosity of at least 5 dL/g.

2. The polymer of claim 1, wherein the monomer mixture comprises,
(a) from 79.5 to 87 mol % of acrylamide or methacrylamide;
(b) from 12.5 to 16.5 mol % of 2-acrylamido-2-methylpropane sulphonic acid, or a salt thereof; and
(c) from 0.5 to 4 mol % of the quaternary ammonium salt of dimethylaminoethyl acrylate or dimethylaminoethyl methacrylate.

3. The polymer of claim 1, wherein the monomer mixture comprises,
(a) from 81 to 86.5 mol % of acrylamide or methacrylamide;
(b) from 13 to 16 mol % of 2-acrylamido-2-methylpropane sulphonic acid, or a salt thereof; and
(c) from 0.5 to 3 mol % of the quaternary ammonium salt of dimethylaminoethyl acrylate or dimethylaminoethyl methacrylate.

4. The polymer of claim 1, wherein (c) comprises the quaternary ammonium salt of dimethylaminoethyl acrylate.

5. The polymer of claim 1, wherein (a) comprises acrylamide.

6. The polymer of claim 1, wherein the reduced specific viscosity is at least 10 dl/g.

7. The polymer of claim 1, wherein the reduced specific viscosity is from 5 to 12 dl/g.

8. The polymer of claim 1, wherein the polymer is water soluble.

9. The polymer of claim 1, wherein the polymer is in the form of a solid powder.

10. The polymer of claim 1, wherein the polymer is in the form of beads.

11. The polymer of claim 1, wherein the polymer is in the form of substantially spherical particles.

12. A process for treating an aqueous slurry comprising a particulate material, the process comprising contacting the aqueous slurry with the polymer of claim 1.

13. The process of claim 12, wherein the polymer is in the form of an aqueous solution.

14. The process of claim 12, wherein the aqueous slurry comprises tailings.

15. The process of claim 12, wherein the aqueous slurry comprises coal tailings, china clay, mineral sands tailings, copper tailings, nickel tailings, gold tailings, oil sands tailings, copper ore concentrate or nickel ore concentrate.

16. The process of claim 12, wherein the aqueous slurry comprises mature fine tailings (MFT).

17. The process of claim 12, wherein the aqueous slurry comprises thin fine tailings (TFT).

18. The process of claim 12, wherein the aqueous slurry comprises whole fine tailings (WFT).

19. The process of claim 12, wherein the contacting is in a vessel and the particulate material settles by gravity sedimentation to form a consolidated layer of solid particles.

20. The process of claim 12, wherein the contacting is in a gravity thickener vessel,
wherein thickened particulate solids are removed from the base of the gravity thickener vessel as an underflow, and
wherein an aqueous liquor is removed from the vessel as an overflow.

21. A process for producing the polymer of claim 1, the process comprising
combining
acrylamide or methacrylamide;
2-acrylamido-2-methylpropane sulphonic acid, or a salt thereof; and
a quaternary ammonium salt of dimethylaminoethyl acrylate or dimethylaminoethyl methacrylate,
to produce a monomer mixture comprising,
(a) from 77 to 88 mol % of acrylamide or methacrylamide;
(b) from 11.9 to 18 mol % of 2-acrylamido-2-methylpropane sulphonic acid, or a salt thereof; and
(c) from 0.1 to 5 mol % of a quaternary ammonium salt of dimethylaminoethyl acrylate or dimethylaminoethyl methacrylate,
wherein the quaternary ammonium salt is a methyl chloride salt or a dimethyl sulphate salt, and
contacting the monomer mixture with at least one initiator.

22. The process of claim 21, wherein the at least one initiator comprises a thermal initiator.

23. The process of claim 21 wherein the at least one initiator comprises an azo compound.

24. The process of claim 21, wherein the at least one initiator comprises a compound selected from the group consisting of azobisisobutyronitrile (AIBN), 4,4′-azobis-(4-cyanovalereic acid) (ACVA) and a mixture thereof.

25. The process of claim 21, wherein the at least one initiator comprises a redox initiator.

26. The process of claim 21, wherein the at least one initiator comprises a redox initiator and at least one thermal initiator.

27. The process of claim 21, wherein the monomer mixture is polymerised by aqueous solution polymerisation to form an aqueous polymer gel, wherein the aqueous polymer gel is cut and dried and formed into a solid powder.

28. The process of claim 21, wherein the monomer mixture is polymerised by reverse-phase suspension polymerisation to form substantially spherical particles or beads.
